(19) United States
(12) Patent Application Publication
(10) Pub. No.: US 2013/0164636 A1
(43) Pub. Date: Jun. 27, 2013

(54) HYBRID ENERGY STORAGE DEVICE

(71) Applicants: JENN-YEU HWANG, KEELUNG CITY (TW); LI-DUAN TSAI, HSINCHU CITY (TW); CHUN-LUNG LI, TAOYUAN COUNTY (TW)

(72) Inventors: JENN-YEU HWANG, KEELUNG CITY (TW); LI-DUAN TSAI, HSINCHU CITY (TW); CHUN-LUNG LI, TAOYUAN COUNTY (TW)

(73) Assignee: INDUSTRIAL TECHNOLOGY RESEARCH INSTITUTE, HSINCHU (TW)

(21) Appl. No.: 13/563,070

(22) Filed: Jul. 31, 2012

(30) Foreign Application Priority Data
Dec. 23, 2011 (TW) 100148213

(51) Int. Cl. H01M 10/056; H01G 9/155; H01M 4/131

(52) U.S. Cl. 429/338; 429/231.2; 429/231.5; 429/231.8; 429/221; 429/339; 429/340; 429/207; 361/502

(57) ABSTRACT

A hybrid energy storage device includes a positive electrode comprising open-structured carbonaceous materials and at least one lithium-containing inorganic compound characterized by LiₓA_{y}(DₜO_{z}), wherein Li is lithium, A is a transition metal, D is selected from the group consisting of silicon, phosphorous, boron, sulfur, vanadium, molybdenum and tungsten, O is oxygen, and x, y, z, t are stoichiometric representation containing real numbers constrained by 0<x≦4, 1≦y≦2, 1≦t≦3, 3≦z≦12, wherein y, t, and z are integers; a negative electrode; and a non-aqueous, lithium-containing electrolyte.

### CROSS-REFERENCE TO RELATED APPLICATIONS

The present application claims the foreign priority of Taiwan Patent Application Serial No. 100,148,213, filed Dec. 23, 2011, and the disclosure of which is hereby incorporated by reference.

### BACKGROUND OF THE INVENTION

1. Technical Field

The present disclosure relates to a hybrid energy storage device.

2. Background

So-called “clean energy” storage devices have been extensively studied and will be the focus of energy storage development for the foreseeable future. The start assisting system and the brake energy regeneration used in hybrid cars require instantaneous high power input and output; wind power and solar power systems require buffer mechanisms in response to the intensity variance of the wind or the light to provide a steady power source and to prolong the life span of the power systems. Therefore, the energy storage devices are expected to face the challenges of storing high energy, delivering high power, and providing long lifetime at the same time. Although lithium-ion secondary batteries have been improved to deliver high power by varying the designs of the electrodes and the materials thereof, there is still room for improvement in terms of meeting the desired power specification and device lifetime. In another respect, the unique high power characteristic and the long lifetime of the existing electric double layer supercapacitors, may not be met by current batteries. The supercapacitor is more appealing to the application end compared to batteries, if the power and lifetime requirements are the important issues. The energy density increase of the energy storage devices allows miniaturization of devices and increases in device lifetime, greatly improving overall functionality of the application.

The stored energy of a capacitor is proportional to its working voltage and its capacity. In order to raise the working voltage of an energy storage capacitor device, asymmetric electrode designs are more favorable than symmetric electrode designs. The positive and negative electrodes use the same materials in the symmetric electrode design, whereas different materials are used for opposite electrodes in the asymmetric electrode design. To increase capacity, electrodes with redox (reduction-oxidation) capability are more widely used than the conventional electric double layer electrodes. The electrode design trend in recent years is moving toward the asymmetrical electrodes using redox material pairs.

For example, an asymmetric design has one electrode composed of activated carbon (AC) conducting physical adsorption/desorption, whereas the other electrode is composed of material that is able to electrochemically insert and release the lithium ions. The capacity of the device in the above recited design is only determined by the extent of the physical adsorption/desorption process, and is therefore limited, which prevents the achievement of high energy density.

To give another example, an energy storage device composed of a positive electrode having lithium-containing transition metal oxide and activated carbon and a negative electrode having carbonaceous materials able to electrochemically insert and release the lithium ions. The aforesaid device uses organic electrolyte.

In the above-mentioned device, if carbonaceous materials are used that are able to electrochemically insert lithium ions as the negative electrode, due to the fact that the insertion reaction potential between the carbonaceous materials and the lithium ions is fairly close to 0V vs. Li/Li⁺, dendritic lithium metal will be deposited on the surface of the carbonaceous materials during the process of fast charging and pierce through the separation membrane, potentially causing a short circuit which raises the safety issue to the energy storage device. FIG. 1 shows reaction potentials with respect to Li/Li⁺ for different materials, wherein the combination of AC/lithium-inserted carbonaceous material (LiC₆) demonstrates a device with a maximum (Max.) working voltage of 4.0V. Because the reaction potential of the lithium-inserted carbonaceous material (LiC₆) is close to the reduction potential of the lithium, lithium metal will unavoidably be deposited on the surface of the carbonaceous material during the process of fast charging, although the negative electrode has a high capacity of 372 mAh/g. FIG. 1 also shows another device having Li₄Ti₅O₁₂ (LTO) as the negative electrode. Because the reaction potential is about 1.5V vs. Li/Li⁺, the maximum (Max.) working voltage of the AC/LTO device is compressed. In addition, the capacity of the negative electrode is only 160 mAh/g, which prevents realization of a device with high energy density.

The present disclosure provides a new energy storage device having a high capacity positive electrode, which conduct more than physical adsorption/desorption process at the electric double layer; and a high capacity, safe negative electrode, which does not incur lithium metal deposition. The energy storage devices disclosed herein may achieve the goal of high energy, small volume, and long device lifetime.

### SUMMARY

One aspect of the present disclosure is to provide a hybrid energy storage device, including a positive electrode, a negative electrode, and a non-aqueous, lithium-containing electrolyte. The positive electrode includes an open-structured carbonaceous material and at least one lithium-containing inorganic compound, wherein the lithium-containing inorganic compound may be presented by a general formula of LiₓA_{y}(DₜO_{z}). In the general formula, Li is lithium, A is transition metal, D is selected from the group consisting of silicon, phosphorous, boron, sulfur, vanadium, molybdenum, and tungsten, O is oxygen, and x, y, t, z are stoichiometrics that are arbitrary numbers greater than zero.

In order to effectively raise the device's working voltage and to ensure the safe operation of the device, the present disclosure selects porous aluminum having a theoretical capacity of 993 mAh/g for the negative electrode. The porous aluminum has several advantages including high capacity, low weight, and a reaction potential between 0.2 and 0.5V vs. Li/Li⁺. Regarding the positive electrode materials, one embodiment of the present disclosure employs compounds releasing lithium ion below or within the range of the open circuit potential of the high-surface-area carbonaceous materials. The compounds undergo a delithiation process, that is, release of lithium ions during charging, to generate the alloying reaction between the negative electrode and lithium ions and achieve high capacity. The high surface area carbonaceous materials and the anions then undergo a reversible adsorption/desorption process, and the lithium-containing compound then undergoes a reversible redox reaction with the involvement of a portion of lithium ions, in order to achieve high capacity, high energy, and high cycling efficiency.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It may be appreciated by those skilled in the art that the conception and specific embodiment disclosed may be readily utilized as a basis for modifying or designing other structures or processes for carrying out the same purposes of the present disclosure. It may also be realized by those skilled in the art that such equivalent constructions do not depart from the spirit and scope of the disclosure as set forth in the appended claims.

### BRIEF DESCRIPTION OF THE DRAWINGS

The present disclosure are illustrated with the following description and upon reference to the accompanying drawings in which:

FIG. 1 shows the electrochemical reaction potential and the working voltage between the activated carbon positive electrode and the following negative electrodes: activated carbon (AC), Li₄Ti₅O₁₂ (LTO), and lithium-inserted carbonaceous material (LiC₆);

FIG. 2A shows the charging process of the hybrid energy storage device;

FIG. 2B shows the discharging process of the hybrid energy storage device;

FIG. 3 shows a voltage to time diagram of a charging/discharging process of an energy storage device according to one embodiment of the present disclosure;

FIG. 4 shows a closed-structured, hybrid energy storage system according to one embodiment of the present disclosure;

FIG. 5 shows a voltage to capacity diagram of a device having an aluminum negative electrode and different positive electrodes including LiCoO₂, LiMn₂O₄, LiFePO₄, Li₂FeSiO₄, and LiFeBO₃, according to one embodiment of the present disclosure;

FIG. 6 shows the potential (V vs. Li/Li⁺) to capacity diagram of a device having different positive electrodes including activated carbon, LiCoO₂, LiMn₂O₄, LiFePO₄, Li₂FeSiO₄, and LiFeBO₃ during charging according to one embodiment of the present disclosure;

FIG. 7 shows a table displaying the materials used as the positive and the negative electrodes in the embodiments and the comparative examples of the present disclosure; and

FIG. 8 shows the capacity to cycling number diagram of an embodiment of the present disclosure.

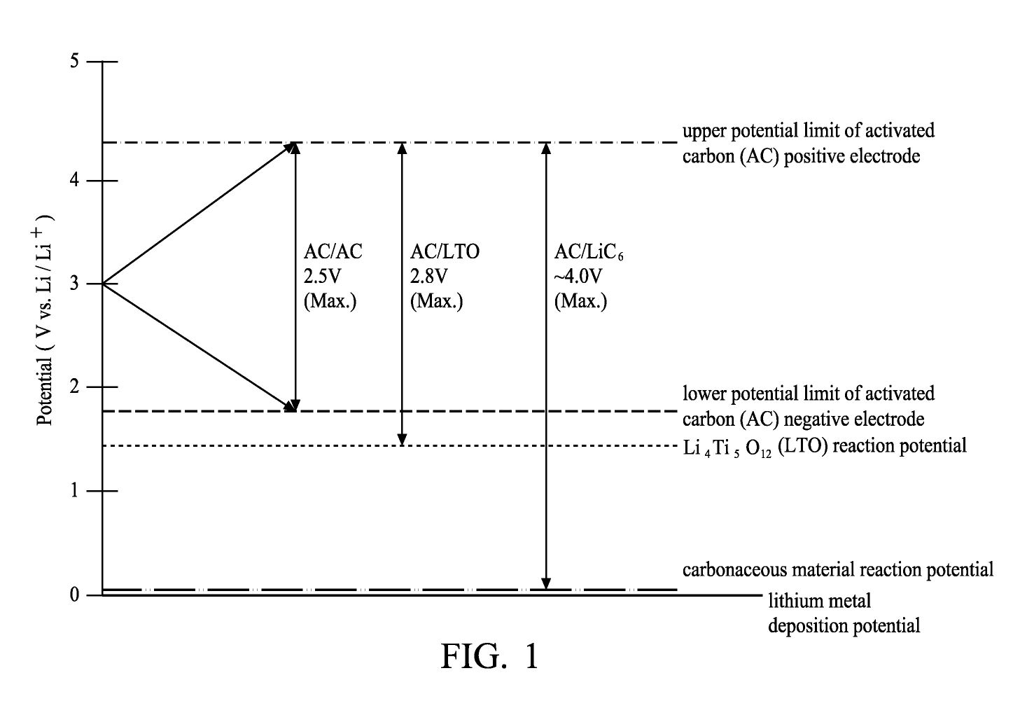

### DETAILED DESCRIPTION

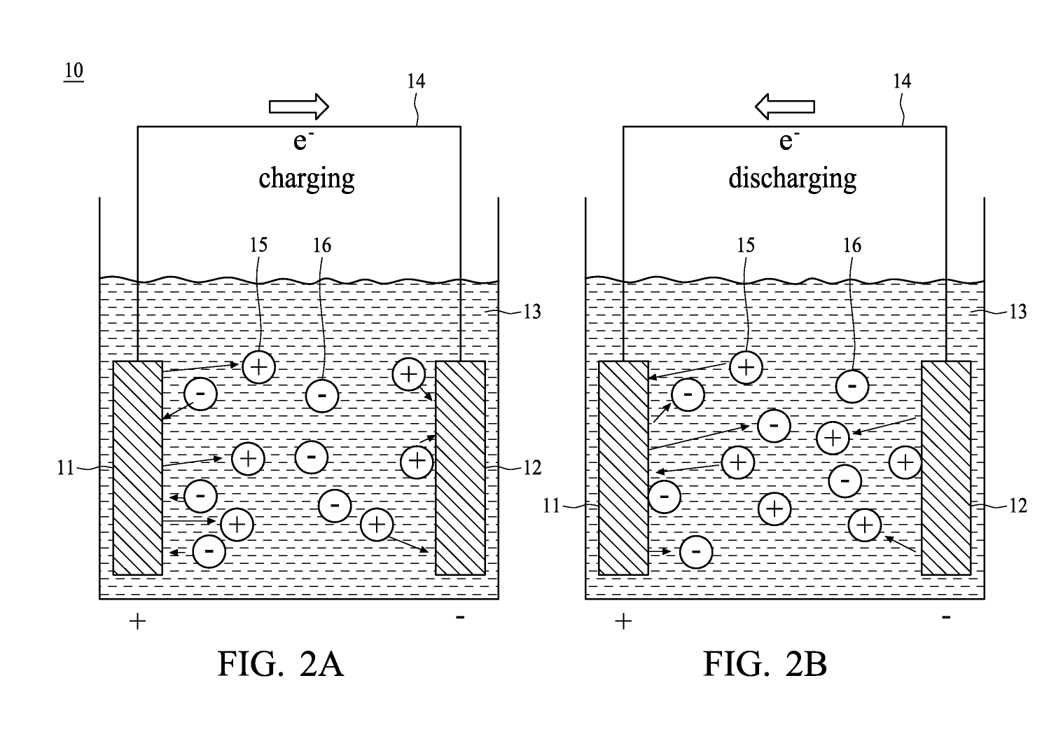

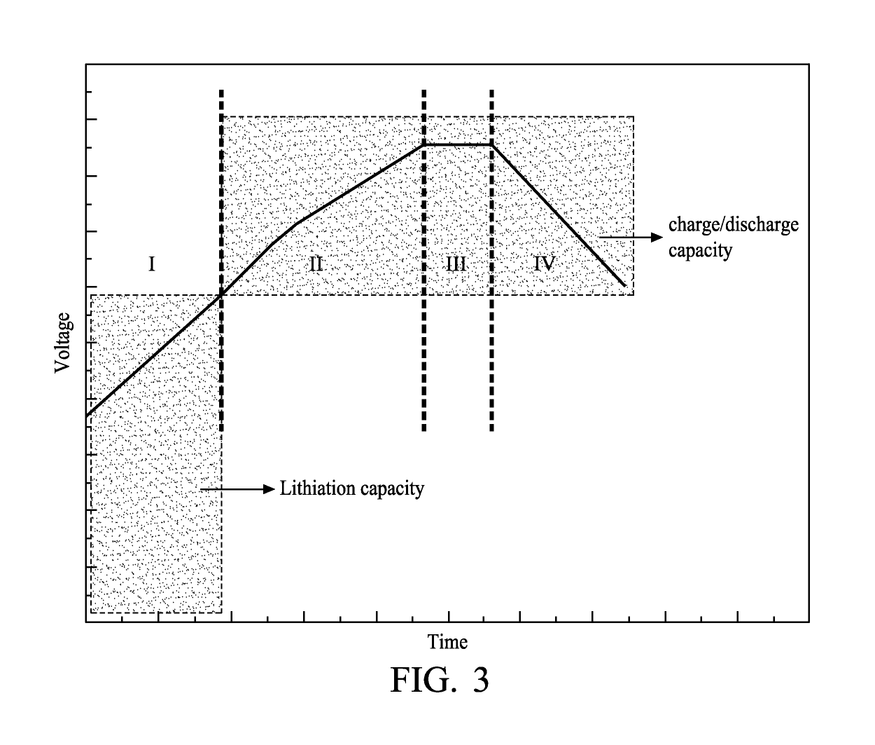

FIG. 2A shows the charging process of a hybrid energy storage device 10: the positive electrode 11 is under an oxidation reaction, releasing lithium ions 15 and adsorbing anions 16. The electrons generated according to the oxidation reaction are transferred from the positive electrode 11 to the negative electrode 12 through an external circuit 14. The electrons received by the negative electrode 12 are then combined with lithium ions 15 under a reduction reaction. FIG. 2B shows the discharging process of a hybrid energy storage device 10: the negative electrode 12 is under an oxidation reaction, releasing a portion of lithium ions 15. The electrons generated according to the oxidation reaction are transferred from the negative electrode 12 to the positive electrode 11 through an external circuit 14. The electrons received by the positive electrode 12 are then combined with a portion of lithium ions 15 under a reduction reaction, and the positive electrode 11 releases anions 16 adsorbed during the charging process. Inside the electrolyte, electron transfer is completed by the transport of anions 16 and lithium ions 15 between the positive electrode 11 and the negative electrode 12. Referring to FIGS. 2A and 2B, the present disclosure provides a hybrid energy storage device having an asymmetric structure, that is, the positive electrode 11 and the negative electrode 12 are made of different materials. The positive electrode 11 includes open-structured, porous carbonaceous materials and lithium-containing inorganic compounds. The lithium-containing inorganic compounds are capable of releasing over 50% of the lithium ions below 3.5V vs. Li/Li⁺, and the open-structured, porous carbonaceous materials include, but are not limited to, activated carbon. As shown in FIG. 3, the charge/discharge process of the present hybrid energy storage device includes two stages: the first stage (I) is the initial portion of the constant current charging. During this stage, the lithium-containing inorganic compounds at the positive electrode 11 release lithium ions, which then undergo a lithiation reaction with the negative electrode 12; therefore, the capacity at such moment is called “lithiation capacity.” The second stage includes the latter portion of the constant current charging (II), constant voltage charging (III), and constant current discharging (IV). During the second stage, the open-structured, porous carbonaceous materials at the positive electrode 11 and the anions in the non-aqueous, lithium-containing electrolyte are under a reversible physical adsorption/desorption process, and a portion of lithium ions and the lithium-containing inorganic compound are involved in another reversible redox reaction. The capacity at the second stage which contains area II, area III, and area IV is labeled “charge/discharge capacity.”

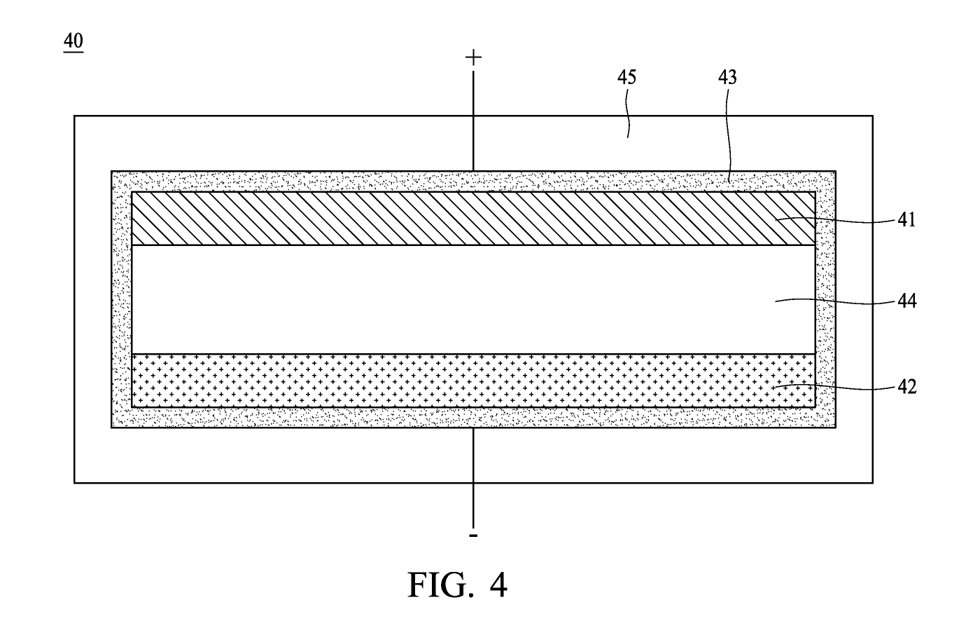

The hybrid energy storage devices provided in the present disclosure may be open-structured or closed-structured, and the devices may further include a separation layer positioned between the positive electrode and the negative electrode in order to prevent the direct contact between the two electrodes and the occurrence of a short circuit. FIG. 4 depicts a schematic diagram of a closed-structured hybrid energy storage device 40, which includes a positive electrode 41, a negative electrode 42, a separation layer 44, an electrolyte 43, and a container 45. The positive electrode 41, the negative electrode 42, and the separation layer 44 are immersed in the electrolyte 43. A container 45 is configured to encase the above-mentioned elements and two electrical leads are guided out from the positive electrode 41 and the negative electrode 42, respectively, so as to be the electrical contacts of the external circuit. The specific position where the electrical leads are guided out may be on the same side or on different sides of the device 40.

According to one embodiment of the present disclosure, the selection of the lithium-containing inorganic compound is based on the following criteria: the compound may be able to release over 50% of the lithium ions below 3.5V vs. Li/Li⁺. Due to the fact that the open circuit potential of the high surface area carbonaceous materials falls between 2.7 and 3.5V vs. Li/Li⁺, and the materials may conduct a reversible adsorption/desorption process to anions between the potential window from the open circuit potential to 4.5V vs. Li/Li⁺, the compound which is capable of releasing lithium ions before or at the initial stage of the anion adsorption process is preferred. The lithium ions released at this stage may facilitate the lithiation reaction at the negative electrode, and the competent candidates are those compounds which are able to release lithium ions below 3.5V vs. Li/Li⁺, in particular, which are able to release over 50% of the lithium ions below 3.5V vs. Li/Li⁺. Hence, the device may retain a broad potential window for anion adsorption/desorption during charging/discharging processes, without compressing the charge/discharge capacity. For the lithium-containing inorganic compound, only partial lithium ions are involved in the redox reaction, and the integral structure of the compound is intact; therefore, a high reversibility and a great cycling efficiency may be retained.

Based on the above-mentioned reasoning, suitable candidates of the lithium-containing inorganic compounds, which are able to conduct a lithiation/delithiation reaction between the potential window of 2.0 to 4.5V vs. Li/Li⁺ at the positive electrode 11 may be, but are not limited to, the following: LiCoO₂ (3.9V vs. Li/Li⁺), LiNiO₂ (3.8V vs. Li/Li⁺), LiMn₂O₄ (4.0V vs. Li/Li⁺), LiFePO₄ (3.4V vs. Li/Li⁺), Li₂FeSiO₄ (2.8V vs. Li/Li⁺), LiFeBO₃ (2.9V vs. Li/Li⁺), LiFeSO4F: (3.6V vs. Li/Li⁺), Li₂FeP₂O₇(3.5V vs. Li/Li⁺), Li₂Fe₂(SO₄)₃ (3.6V vs. Li/Li⁺), Li₂Fe₂(MoO₄)₃ (3.0V vs. Li/Li⁺), Li₂Fe₂(WO₄)₃ (3.0V vs. Li/Li⁺), Li₄Fe(MoO₄)₃ (2.4V vs. Li/Li⁺), and the combination thereof. If compounds with higher electrochemical potentials are used, the anions adsorption/desorption potential window at the positive electrode will be compressed, and the capacity as well as the energy density will be decreased. Compounds with low electrochemical potentials for oxidation reactions and involving Fe²⁺/Fe³⁺, V²⁺/V³⁺, V³⁺/V⁴⁺, V⁴⁺/V⁵⁺, Nb³⁺/Nb⁴⁺, Nb⁴⁺/Nb⁵⁺, and Ti³⁺/Ti⁴⁺ change in valence state may be used in the present disclosure. Preferably, LiFePO₄, Li₂FeSiO₄, LiFeBO₃, LiFeSO₄F, Li₂FeP₂O₇, Li₂Fe₂(SO₄)₃, Li₂Fe₂(MoO₄)₃, Li₂Fe₂(WO₄)₃, and Li₄Fe(MoO₄)₃ are suitable compounds that involve Fe²⁺/Fe³⁺ oxidation reaction. According to one embodiment of the present disclosure, the materials of the positive electrode 11 include high surface area carbonaceous materials and lithium-containing inorganic compound. The ratio of weight percent of the two materials may be in a range of from 1:20 to 20:1. If the ration of weight percent is less than 1:20, the deficit of the reversible capacity may occur; if the ratio of weight percent is greater than 20:1, the capacity may not be raised effectively; therefore, the optimal ratio of weight percent is in a range of from 1:10 to 10:1.

The negative electrode of the energy storage device utilizes the alloying reaction between the lithium ion and the metal/nonmetal to achieve high capacity. The reaction of lithiation/delithiation occurs under particular electrochemical potential, for example, Bi (0.8V vs. Li/Li⁺), Sb (0.9V vs. Li/Li⁺), Sn (0.5V vs. Li/Li⁺), Si (0.4V vs. Li/Li⁺), Al (0.3V vs. Li/Li⁺), and In (0.6V vs. Li/Li⁺). However, the above-mentioned alloying reaction usually accompanies vigorous volume expansion, causing the active material to disconnect from electrode and lose good electron conducting pathway, resulting in a short cycling lifetime. Materials with a sufficient conducting network and a buffering structure able to absorb the volume variation are required to be selected as the negative electrode. The negative electrode 12 of the hybrid energy storage device according to one embodiment of the present disclosure includes porous aluminum, which is present to be electrochemically active to the lithium ions. The porous structure of the aluminum is retained to absorb the mechanical stress as a result of the volume expansion. Being a metal with good electric conductivity, aluminum may form a well-structured electrical conducting network or current collector at the electrode with active materials, given that no extra conductive agent is applied. In another embodiment of the present disclosure, aluminum foil may also be used directly as an active electrode such that complicated electrode preparation procedures such as dispersion, coating, drying, and roll pressing may be avoided. Due to the fact that aluminum is low in mass, the energy density of the energy storage device may be more effectively raised compared to the implementation of heavy metal. An aluminum negative electrode in one embodiment of the present disclosure possesses low lithiation/delithiation reaction potential (0.3V vs. Li/Li⁺), is free of safety concerns (no lithium metal deposition), and provides high capacity.

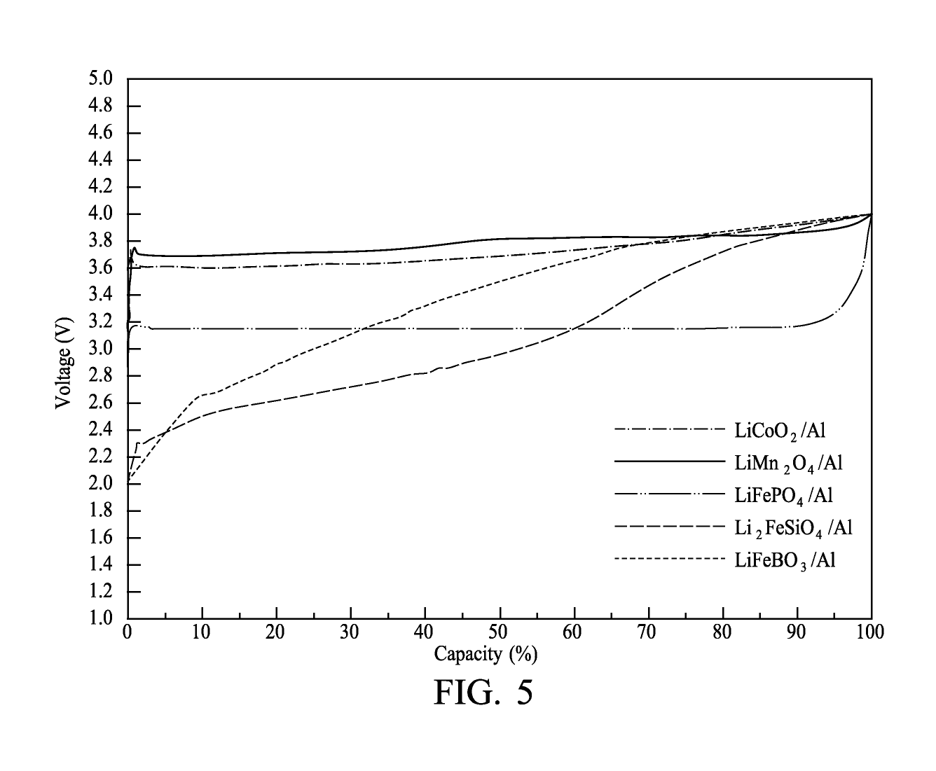

FIG. 5 shows a diagram of voltage to device capacity of various energy storage devices containing LiCoO₂, LiMn₂O₄, LiFePO₄, Li₂FeSiO₄, or LiFeBO₃ as the positive electrode and aluminum as the negative electrode. The device combination of LiFePO₄/Al (positive/negative electrode) possesses a lithium-releasing voltage plateau starting at about 3.15V; the device combination of Li₂FeSiO₄/Al (positive/negative electrode) starts to release lithium ions at about 2.32V; and the device combination of LiFeBO₃/Al (positive/negative electrode) possesses the ability of releasing lithium ions starting at about 2.67V. Only after going beyond the lithium-ion releasing voltage may the device combination start to release lithium ions, that is, when the lithium-containing inorganic compound is adopted to be the positive electrode, in order to ensure the released lithium ions are practically involved in the lithiation reaction at the negative electrode, the working voltage of the device may be operated at a level higher than the initial lithium-releasing voltage. The lower limits of the working voltage according to the above-mentioned electrode combinations are: LiFePO₄/Al (3.2V), Li₂FeSiO₄/Al (2.4V), and LiFeBO₃/Al (2.7V). In contrast, not until 3.58V may the device combination of LiCoO₂/Al (positive/negative electrode) be capable of releasing lithium ions, the plateau applies to the device combination of LiMn₂O₄/Al (positive/negative electrode) at about 3.64V. Therefore, the lower limits of the device working voltage are LiCoO₂/Al (3.6V) and LiMn₂O₄/Al (3.7V), substantially compressing the working voltage window of device. In other words, the electrode combination containing LiFePO₄, Li₂FeSiO₄, and LiFeBO₃ may have a broader working voltage window.

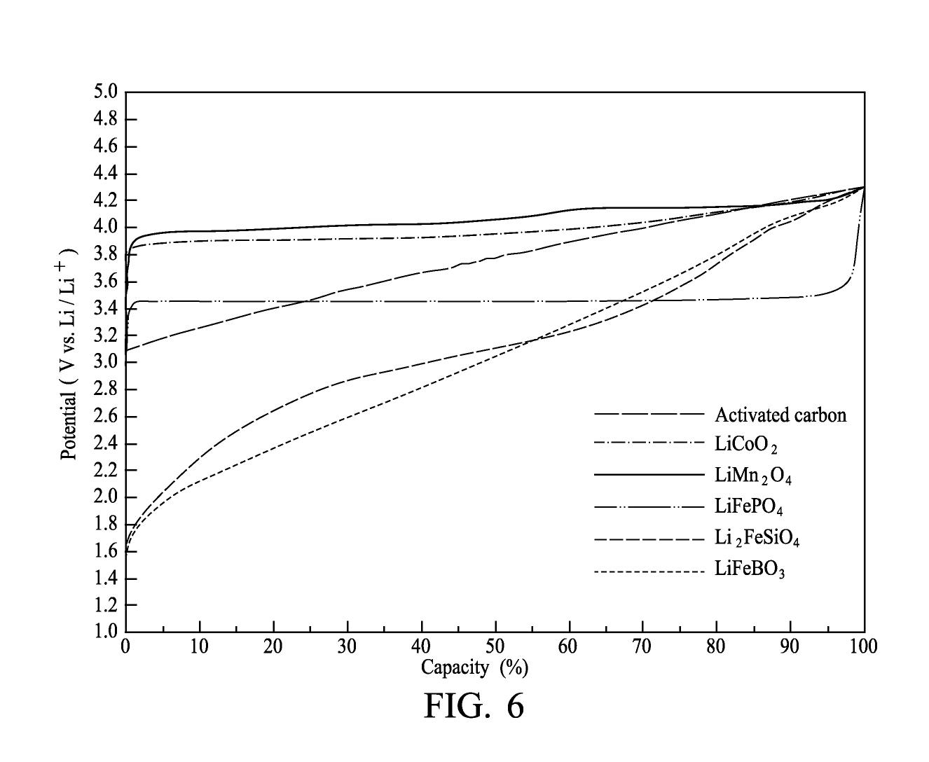

FIG. 6 shows the relationship between the potential and the capacity when various active materials are under charging conditions. The extent for the activated carbon to adsorb anions varies with different potentials, while compounds like Li₂FeSiO₄ and LiFeBO₃ start to release lithium ions at a potential level lower than the potential level at which the activated carbon starts to adsorb anions. As shown in FIG. 6, adopting Li₂FeSiO₄ and LiFeBO₃ to be the materials for positive electrode may result in retaining of a broader potential window for the anion adsorption/desorption process, and a higher charge/discharge capacity.

The hybrid energy storage device according to embodiments of the present disclosure includes a positive electrode 11, a negative electrode 12, and a non-aqueous, lithium containing electrolyte. The positive electrode 11 includes high surface area carbonaceous materials and at least one lithium-containing inorganic compound, wherein the lithium-containing inorganic compound may be presented by a general formula of LiₓA_{y}(DₜO_{z}); Li is lithium, A is transition metal, D is selected from the group consisting of silicon, phosphorous, boron, sulfur, vanadium, molybdenum, and tungsten, and O is oxygen; and x, y, t, z are stoichiometrics that are arbitrary numbers greater than zero. Because the valence state of transition metal changes during the redox reactions, during the process of the lithiation/delithiation, the stoichiometrics x, y, t, z are each in a range of 0<x≦4, 1≦y≦2, 1≦t≦3, and 3≦z≦12, wherein y, t, z are all integers. The high surface area carbonaceous materials positioned at the positive electrode 11 may be activated carbon having a surface area ranges from 1500 to 3500 m²/g.

The present hybrid energy storage device may be open-structured or closed-structured; in addition, the device may further including a separation layer, positioned between the positive electrode and the negative electrode so as to prevent short circuit. The structure of the separation layer may be porous polymer, polymer composites, polymer/inorganic composite, natural fiber, synthetic fiber, composite of natural fiber/synthetic fiber, and the combination thereof. The polymer materials in the separation layer may be selected from polyethylene (PE), polypropylene (PP), poly(ethylene terephthalate) (PET), poly(ethylene oxide) (PEO), polyacrylonitrile (PAN), poly(methyl methacrylate) (PMMA), poly(vinylidene fluoride) (PVDF), poly(vinylidene fluoride co-hexafluoropropylene) (PVDF-co-HFP), poly(tetrafluoroethylene) (PTFE), and the combination thereof.

The electrolyte of the hybrid energy storage device includes solvent and dissociable salts which generate lithium ions and anions. The solvent in the present embodiments may be selected from non-aqueous solvent such as propylene carbonate (PC), ethylene carbonate (EC), fluoroethylene carbonate (FEC), dimethyl carbonate (DMC), diethyl carbonate (DEC), ethyl methyl carbonate (EMC), vinylene carbonate (VC), γ-butyrolactone (GBL), 1,2-dimethoxyethane (DME), 1,3-dioxolane (DOL), tetrahydrofuran (THF), sulfolane, acetonitrile, the combination thereof, or the like. The dissociable salts which generate lithium ions and anions in the present embodiments may be selected from LiPF₆, LiBF₄, LiClO₄, LiAsF₆, LiB(C₂O₄)₂, LiBF₂C₂O₄, LiPF₄C₂O₄, LiCF₃SO₃, LiN(CF₃SO₂)₂, LiN(C₂F₅SO₂)₂, LiC(CF₃SO₂)₃, the combination thereof, or the like.

The electrochemical performance evaluation for the electrode materials according to the present disclosure is conducted by first mixing the active materials, conductive carbons, and binders; coating the composites on a substrate; immersing the coated substrate into the electrolyte; and conducting a charge/discharge test. The conductive carbon may be carbon black, graphite, carbon fiber, and the combination thereof; the binder may be poly(vinylidene fluoride) (PVDF), poly(tetrafluoroethylene) (PTFE), carboxymethyl cellulose (CMC), styrene butadiene rubber (SBR), ethylene propylene diene monomer rubber (EPDM rubber), polyacrylate, polyimide, poly(vinyl alcohol) (PVA), polyvinylpyrrolidone (PVP), the combination thereof, or the like.

### Embodiment 1

### The Electrochemical Evaluation of the Lithium-Containing Transition Metal Inorganic Compound

The positive electrode of the embodiment is composed of active materials such as LiCoO₂, LiMn₂O₄, LiFePO₄, Li₂FeSiO₄, LiFeBO₃, and activated carbon, in addition, conductive carbons such as carbon black, graphite, and carbon fibers are mixed with binders as well as the active materials to be coated on an aluminum foil. The negative electrode is lithium metal. A separation layer (PP/PE) may be further disposed between the positive and the negative electrodes. The electrolyte used in the present embodiment is 1M LiPF₆ (EC/EMC). The device of the embodiment is charged under constant current to 4.3V to get the total capacity from the release of lithium ions, and the capacity below the potential 3.5V vs. Li/Li' is calculated in percentage with respect to the total capacity.

FIG. 6 shows the relationship between the potential and the capacity when various active materials are under charging conditions. For activated carbon, the capacity below 3.5V vs. Li/Li⁺ is 27% of the total capacity. For other lithium-containing transition metal inorganic compounds, the percentages of the capacity below 3.5V vs. Li/Li⁺ with respect to the total capacity are: LiCoO₂: 0.03%, LiMn₂O₄: 0.09%, LiFePO₄: 93.7%, Li₂FeSiO₄: 73%, and LiFeBO₃: 69%. Note that the capacity from the release of lithium ions below 3.5V vs. Li/Li⁺ may contribute more than 50% of the total capacity for LiFePO₄, Li₂FeSiO₄, and LiFeBO₃.

### Embodiment 2

### Asymmetric Electrode Structure: Activated Carbon+LiFePO₄/Porous Aluminum

The positive electrode of the embodiment is composed of high surface area (2350 to 3000 m²/g) activated carbon and LiFePO₄ in a weight percent ratio of 5:1. In addition, conductive carbons such as carbon black, graphite, and carbon fibers are mixed with binders as well as the activated carbon and LiFePO₄ to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 3.2V to 4.0V.

The electrochemical evaluation according to the present embodiment is conducted by charging the device under constant current of 0.1 mA to 4.0V, maintaining the voltage at 4.0V, and then discharging the device under constant current of 0.1 mA to 3.2V. The discharge capacity of the device in the present embodiment is 28.5 F/cm³, and the energy density is 17.8 Wh/L during the charge/discharge process in the range of 3.2V to 4.0V. The discharge capacity and the energy density are calculated based on the total volume of the positive and the negative electrodes.

### Embodiment 3

### Asymmetric Electrode Structure: Activated Carbon+Li₂FeSiO₄/Porous Aluminum

The positive electrode of the embodiment is composed of high surface area (2350 to 3500 m²/g) activated carbon and Li₂FeSiO₄ in a weight percent ratio of 5:1. In addition, conductive carbons such as carbon black, graphite, and carbon fibers are mixed with binders as well as the activated carbon and Li₂FeSiO₄ to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 2.4V to 4.0V.

The electrochemical evaluation according to the present embodiment is conducted by charging the device under constant current of 0.1 mA to 4.0V, maintaining the voltage at 4.0V, and then discharging the device under constant current of 0.1 mA to 2.4V. The discharge capacity of the device in the present embodiment is 39.2 F/cm³, and the energy density is 29.7 Wh/L during the charge/discharge process in the range of 2.4V to 4.0V. The discharge capacity and the energy density are calculated based on the total volume of the positive and the negative electrodes.

### Embodiment 4

### Asymmetric Electrode Structure: Activated Carbon+LiFeBO₃/Porous Aluminum

The positive electrode of the embodiment is composed of high surface area (2300 to 3200 m²/g) activated carbon and LiFeBO₃ in a weight percent ratio of 5:1. In addition, conductive carbons such as carbon black, graphite, and carbon fibers are mixed with binders as well as the activated carbon and LiFeBO₃ to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 2.7V to 4.0V.

The electrochemical evaluation according to the present embodiment is conducting by charging the device under constant current of 0.1 mA to 4.0V, maintaining the voltage at 4.0V, and then discharging the device under constant current of 0.1 mA to 2.7V. The discharge capacity of the device in the present embodiment is 32.9 F/cm³, and the energy density is 27.9 Wh/L during the charge/discharge process in the range of 2.7V to 4.0V. The discharge capacity and the energy density are calculated based on the total volume of the positive and the negative electrodes.

### Comparative Example 1

### Symmetric Electrode Structure: Activated Carbon/Activated Carbon

The positive electrode of the embodiment is composed of high surface area (1800 to 2800 m²/g) activated carbon. In addition, conductive carbons such as carbon black, graphite, and carbon fibers are mixed with binders as well as the activated carbon to be coated on an aluminum foil. The negative electrode is composed of the same materials as the positive electrode. A separation layer (natural fiber/synthetic fiber composite) may be further disposed between the positive and the negative electrodes. The electrolyte used in the present embodiment is 1M (C₂H₅)₄NPF₆ (PC). The device in the present embodiment possesses a working voltage range of 0V to 2.5V.

The electrochemical evaluation according to the present embodiment is conducted by charging the device under constant current of 0.1 mA to 2.5V, maintaining the voltage at 2.5V, and then discharging the device under constant current of 0.1 mA to 0V. The discharge capacity of the device in the present embodiment is 9.3 F/cm³, and the energy density is 7.2 Wh/L during the charge/discharge process in the range of 0V to 2.5V. The discharge capacity and the energy density are calculated based on the total volume of the positive and the negative electrodes.

### Comparative Example 2

Asymmetric electrode structure: Activated carbon/Porous Aluminum

The positive electrode of the embodiment is composed of high surface area (2350 to 3000 m²/g) activated carbon. In addition, conductive carbons such as carbon black, graphite, and carbon fibers are mixed with binders as well as the activated carbon to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 3.2V to 4.0V.

The electrochemical evaluation according to the present embodiment is conducted by charging the device under constant current of 0.1 mA to 4.0V, maintaining the voltage at 4.0V, and then discharging the device under constant current of 0.1 mA to 3.2V. The discharge capacity of the device in the present embodiment is 22.5 F/cm³, and the energy density is 13.9 Wh/L during the charge/discharge process in the range of 3.2V to 4.0V. The discharge capacity and the energy density are calculated based on the total volume of the positive and the negative electrodes.

### Comparative Example 3

### Asymmetric Electrode Structure: Activated Carbon+LiCoO₂/Porous Aluminum

The positive electrode of the embodiment is composed of high surface area (2100 to 2800 m²/g) activated carbon and LiCoO₂ in a weight percent ratio of 5:1. In addition, conductive carbons such as carbon black, graphite, and carbon fibers are mixed with binders as well as the activated carbon to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 3.6V to 4.0V.

The electrochemical evaluation according to the present embodiment is conducted by charging the device under constant current of 0.1 mA to 4.0V, maintaining the voltage at 4.0V, and then discharging the device under constant current of 0.1 mA to 3.6V. The discharge capacity of the device in the present embodiment is 23.6 F/cm³, and the energy density is 5.7 Wh/L during the charge/discharge process in the range of 3.6V to 4.0V. The discharge capacity and the energy density are calculated based on the total volume of the positive and the negative electrodes.

### Comparative Example 4

### Asymmetric Electrode Structure: Activated Carbon+LiMn₂O₄/Porous Aluminum

The positive electrode of the embodiment is composed of high surface area (2000 to 2900 m²/g) activated carbon and LiMn₂O₄ in a weight percent ratio of 5:1. In addition, conductive carbons such as carbon black, graphite, and carbon fibers are mixed with binders as well as the activated carbon to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 3.7V to 4.0V.

The electrochemical evaluation according to the present embodiment is conducted by charging the device under constant current of 0.1 mA to 4.0V, maintaining the voltage at 4.0V, and then discharging the device under constant current of 0.1 mA to 3.7V. The discharge capacity of the device in the present embodiment is 16.9 F/cm³, and the energy density is 3.6 Wh/L during the charge/discharge process in the range of 3.7V to 4.0V. The discharge capacity and the energy density are calculated based on the total volume of the positive and the negative electrodes.

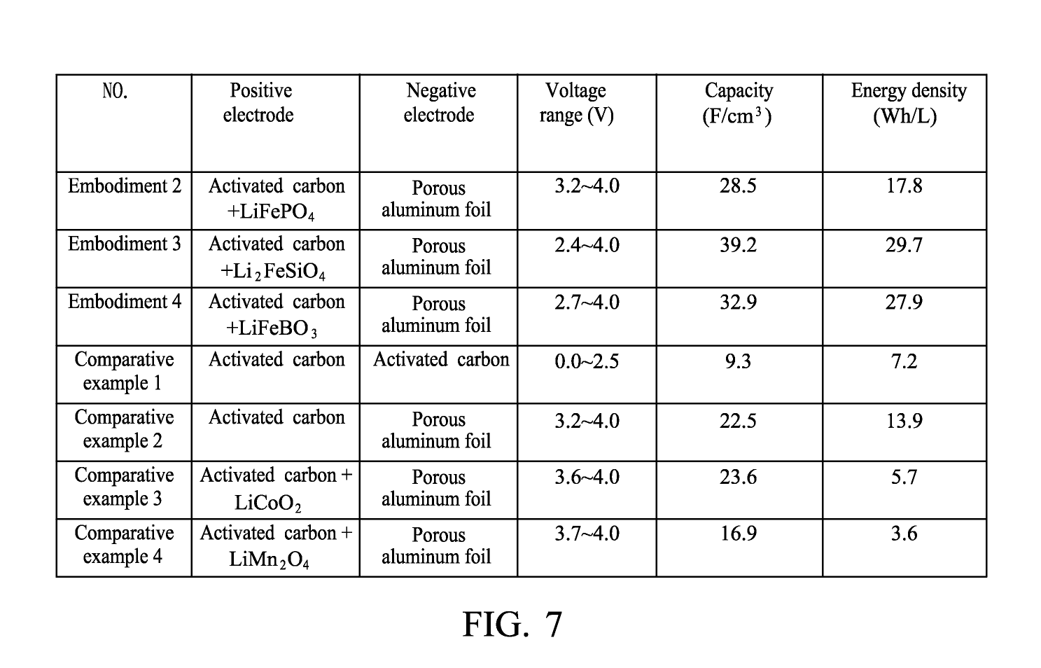

FIG. 7 shows a table displaying the materials used as the positive and the negative electrodes in the Embodiments 2 to 4 and the Comparative Examples 1 to 4 of the present disclosure, wherein the designs of asymmetric electrode show higher capacity. The device in Comparative Example 2 acts as a control group because only activated carbon is present at the positive electrode. The positive electrodes of the Comparative Examples 3 and 4 include activated carbon and lithium-containing inorganic compound, LiCoO₂ and LiMn₂O₄, respectively. The capacity in Comparative Examples 3 and 4 is similar to that in Comparative Example 2, since the delithiation potential is relatively high in LiCoO₂ and LiMn₂O₄ and actual working voltage range is compressed, resulting in a low energy density. In contrast, the positive electrodes of Embodiments 2, 3, and 4 include LiFePO₄, Li₂FeSiO₄, and LiFeBO₃, respectively. The three above-mentioned compounds are characterized by low delithiation potential. These three embodiments not only present a broader range of actual working voltage but also a highly reversible redox reaction with high efficiency performed by the lithium ions, hence a higher capacity and energy density is achieved.

Referring to Embodiments 2 to 4 in FIG. 7, the present disclosure provides a combination of high surface area carbonaceous materials, lithium-containing inorganic compounds such as LiFePO₄, Li₂FeSiO₄, or LiFeBO₃ as the positive electrode, along with a porous aluminum as the negative electrode, an electrolyte containing solvents and dissociable salts that generate lithium ions and anions. The combination of the embodiments demonstrates a higher discharge capacity and energy density compared to other comparative examples.

### Embodiment 5

### Asymmetric Electrode Structure: Activated Carbon+LiFePO₄/Porous Aluminum

The positive electrode of the embodiment is composed of high surface area (1500 to 2000 m²/g) activated carbon and LiFePO₄ in a weight percent ratio of 1:10. In addition, conductive carbons such as carbon black, graphite, and carbon fibers are mixed with binders as well as the activated carbon and LiFePO₄ to be coated on an aluminum foil. The negative electrode is composed of porous aluminum foil. A separation layer (PP/PE) may be further disposed between the positive and the negative electrodes. The electrolyte used in the present embodiment is 1M LiPF₆ (EC/EMC). The device in the present embodiment possesses a working voltage range of 3.2V to 4.0V. The electrochemical evaluation according to the present embodiment is conducted by charging the device under constant current of 0.4 mA to 4.0V, maintaining the voltage at 4.0V, and then discharging the device under constant current of 0.4 mA to 3.2V.

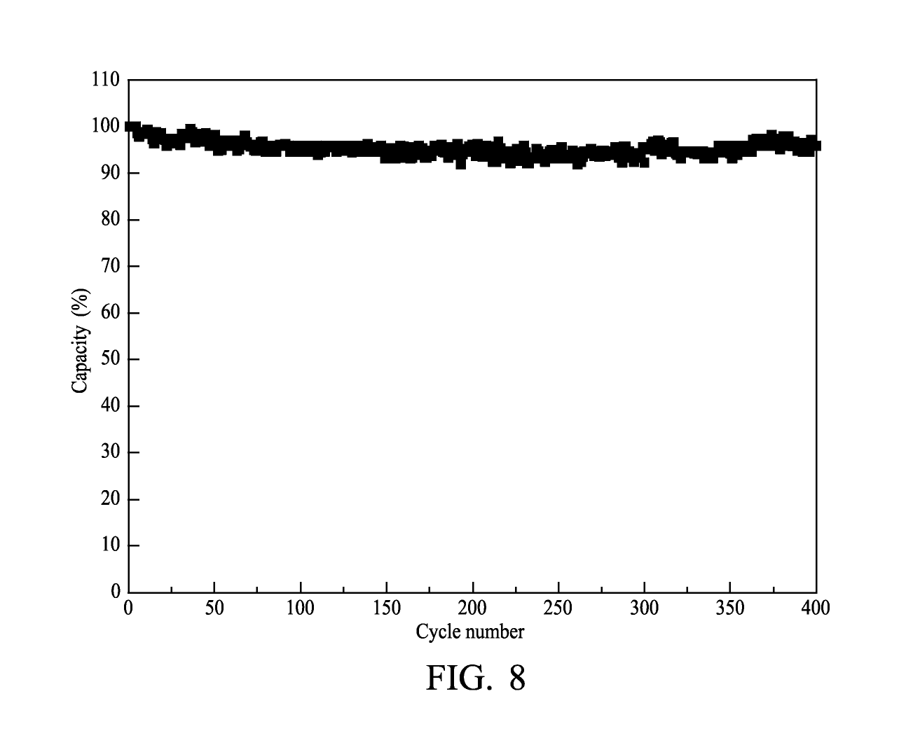

As shown in FIG. 8, during the charge/discharge process in the range of 3.2V to 4.0V, the measured capacity after 400 cycles is maintained at 96% of the initial total capacity. As a result, the embodiment of the present disclosure not only possesses the characteristics of high capacity and high energy density, but also excellent cycling performance after a large number of cycles.

One aspect of the present disclosure provides an open-structured or closed-structured hybrid energy storage device, the device including a positive electrode, a negative electrode, and a non-aqueous, lithium-containing electrolyte. The positive electrode includes an open-structured carbonaceous material and at least one lithium-containing inorganic compound, wherein the lithium-containing inorganic compound may be presented by a general formula of LiₓA_{y}(DₜO_{z}). In the general formula, Li is lithium, A is transition metal, D is selected from the group consisting of silicon, phosphorous, boron, sulfur, vanadium, molybdenum, and tungsten, O is oxygen, and x, y, t, z are stoichiometrics that are arbitrary numbers greater than zero. The hybrid energy storage device further includes a separation layer positioned between the positive electrode and the negative electrode, in order to prevent the direct contact between the two electrodes and the occurrence of a short circuit. To effectively raise the working voltage and to ensure the safety of the device, the negative electrode in the present disclosure includes porous aluminum which possesses high capacity, light weight, and a reaction potential of between 0.2 and 0.5V vs. Li/Li⁺. Regarding the positive electrode materials, one embodiment of the present disclosure employs compounds releasing lithium ions below or within the range of the open circuit potential of the high-surface-area carbonaceous materials. The compounds undergo a delithiation process, that is, lithium ions are released during charging, in order to generate the alloying reaction between the negative electrode and lithium ions, thereby achieving high capacity. The high surface area carbonaceous materials and the anions then undergo a reversible adsorption/desorption process, and the lithium-containing compound then undergoes a reversible redox reaction with the involvement of a portion of lithium ions, in order to achieve high capacity, high energy, and high cycling efficiency.

Although the present disclosure and its advantages have been described in detail, it may be understood that various changes, substitutions and alterations may be made herein without departing from the spirit and scope of the disclosure as defined by the appended claims. For example, many of the processes discussed above may be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A hybrid energy storage device, comprising:
a positive electrode, comprising
an open-structured carbonaceous material; and
at least one lithium-containing inorganic compound;
wherein the lithium-containing inorganic compound is presented by a general formula of LiₓA_{y}(DₜO_{z});
wherein Li is lithium, A is transition metal, D is selected from the group consisting of silicon, phosphorous, boron, sulfur, vanadium, molybdenum, and tungsten, O is oxygen; and
x, y, t, z are stoichiometrics that are arbitrary numbers greater than zero;
a negative electrode; and
a non-aqueous, lithium-containing electrolyte.

2. The hybrid energy storage device of claim 1, wherein the stoichiometrics x, y, t, z are constrained by 0<x≦4, 1≦y≦2, 1≦t≦3, and 3≦z≦12, and wherein y, t, z are all integers.

3. The hybrid energy storage device of claim 2, wherein the open-structured carbonaceous materials comprise high surface area activated carbon.

4. The hybrid energy storage device of claim 3, wherein the surface area of the activated carbon is in a range of from 1500 to 3500 m²/g.

5. The hybrid energy storage device of claim 1, wherein the lithium-containing inorganic compound further comprises LiFeSO₄F.

6. The hybrid energy storage device of claim 5, wherein the weight ratio of the open-structured carbonaceous materials to the lithium-containing inorganic compound is in a range of from 1:10 to 10:1.

7. The hybrid energy storage device of claim 1, wherein the non-aqueous, lithium-containing electrolyte comprises a solvent selected from the group consisting of propylene carbonate, ethylene carbonate, fluoroethylene carbonate, dimethyl carbonate, diethyl carbonate, ethyl methyl carbonate, vinylene carbonate, γ-butyrolactone, 1,2-dimethoxyethane, 1,3-dioxolane, tetrahydrofuran, sulfolane, acetonitrile, and the combination thereof.

8. The hybrid energy storage device of claim 1, wherein the non-aqueous, lithium-containing solution comprises a dissociable salt selected from the group consisting of LiPF₆, LiBF₄, LiClO₄, LiAsF₆, LiB(C₂O₄)₂, LiBF₂C₂O₄, LiPF₄C₂O₄, LiCF₃SO₃, LiN(CF₃SO₂)₂, LiN(C₂F₅SO₂)₂, LiC(CF₃SO₂)₃, and the combination thereof.

9. The hybrid energy storage device of claim 1, further comprising a separation layer, positioned between the positive electrode and the negative electrode.

10. The hybrid energy storage device of claim 9, wherein the separation layer comprises porous polymer, polymer composites, polymer/inorganic composites, natural fibers, synthetic fibers, or natural fiber/synthetic fiber composites having polymer materials selected from the group consisting of polyethylene, polypropylene, poly(ethylene terephthalate), poly(ethylene oxide), polyacrylonitrile, poly(methyl methacrylate), poly(vinylidene fluoride), poly(vinylidene fluoride co-hexafluoropropylene), poly(tetrafluoroethylene), and the combination thereof.

11. A closed-structured, hybrid energy storage device, comprising:
a positive electrode, comprising
an open-structured carbonaceous material; and
at least one lithium-containing inorganic compound;
wherein the lithium-containing inorganic compound is presented by a general formula of LiₓA_{y}(DₜO_{z});
wherein Li is lithium, A is transition metal, D is selected from the group consisting of silicon, phosphorous, boron, sulfur, vanadium, molybdenum, and tungsten, O is oxygen; and
x, y, t, z are stoichiometrics that are arbitrary numbers greater than zero;
a negative electrode;
a non-aqueous, lithium-containing electrolyte, wherein the lithium ion in the electrolyte is transferred between the positive electrode and the negative electrode; and
a container accommodating the positive electrode, the negative electrode, and the non-aqueous, lithium-containing electrolyte.

12. A closed-structured, hybrid energy storage device as in claim 11, wherein the stoichiometrics x, y, t, z are each in a range of 0<x≦4, 1≦y≦2, 1≦t≦3, and 3≦z≦12, and wherein y, t, z are all integers.

13. The hybrid energy storage device of claim 12, wherein the open-structured carbonaceous materials comprise high surface area activated carbon.

14. The hybrid energy storage device of claim 13, wherein the surface area of the activated carbon is in a range of from 1500 to 3500 m²/g.

15. The hybrid energy storage device of claim 11, wherein the lithium-containing inorganic compound further comprises LiFeSO₄F.

16. The hybrid energy storage device of claim 15, wherein the weight ratio of the open-structured carbonaceous materials to the lithium-containing inorganic compound is in a range of from 1:10 to 10:1.

17. The hybrid energy storage device of claim 11, wherein the non-aqueous, lithium-containing electrolyte comprises a solvent selected from the group consisting of propylene carbonate, ethylene carbonate, fluoroethylene carbonate, dimethyl carbonate, diethyl carbonate, ethyl methyl carbonate, vinylene carbonate, γ-butyrolactone, 1,2-dimethoxyethane, 1,3-dioxolane, tetrahydrofuran, sulfolane, acetonitrile, and the combination thereof.

18. The hybrid energy storage device of claim 11, wherein the non-aqueous, lithium-containing solution comprises a dissociable salt selected from the group consisting of LiPF₆, LiBF₄, LiClO₄, LiAsF₆, LiB(C₂O₄)₂, LiBF₂C₂O₄, LiPF₄C₂O₄, LiCF₃SO₃, LiN(CF₃SO₂)₂, LiN(C₂F₅SO₂)₂, LiC(CF₃SO₂)₃, and the combination thereof.

19. The hybrid energy storage device of claim 11, further comprising a separation layer, positioned between the positive electrode and the negative electrode.

20. The hybrid energy storage device of claim 19, wherein the separation layer comprises porous polymer, polymer composites, polymer/inorganic composites, natural fibers, synthetic fibers, or natural fiber/synthetic fiber composites having polymer materials selected from the group consisting of polyethylene, polypropylene, poly(ethylene terephthalate), poly(ethylene oxide), polyacrylonitrile, poly(methyl methacrylate), poly(vinylidene fluoride), poly(vinylidene fluoride co-hexafluoropropylene), poly(tetrafluoroethylene), and the combination thereof.

21. A hybrid energy storage device, comprising:
a positive electrode, comprising
an open-structured carbonaceous material; and
at least one lithium-containing inorganic compound;
wherein the lithium-containing inorganic compound is presented by a general formula of LiₓA_{y}(DₜO_{z});
wherein Li is lithium, A is transition metal, D is selected from the group consisting of silicon, phosphorous, boron, sulfur, vanadium, molybdenum, and tungsten, O is oxygen; and
x, y, t, z are stoichiometrics that are arbitrary numbers greater than zero;
a negative electrode, comprising aluminum material; and
a non-aqueous, lithium-containing electrolyte.

22. The hybrid energy storage device of claim 21, wherein the stoichiometrics x, y, t, z are each in a range of 0≦x≦4, 1≦y≦2, 1≦t≦3, and 3≦z≦12, wherein y, t, z are all integers.

23. The hybrid energy storage device of claim 22, wherein the aluminum material comprises porous aluminum.

24. The hybrid energy storage device of claim 22, wherein the open-structured carbonaceous materials comprises high surface area activated carbon.

25. The hybrid energy storage device of claim 24, wherein the surface area of the activated carbon is in a range of from 1500 to 3500 m²/g.

26. The hybrid energy storage device of claim 21, wherein the lithium-containing inorganic compound further comprises LiFeSO₄F.

27. The hybrid energy storage device of claim 26, wherein the weight ratio of the open-structured carbonaceous materials to the lithium-containing inorganic compound is in a range of from 1:10 to 10:1.

28. The hybrid energy storage device of claim 21, wherein the non-aqueous, lithium-containing electrolyte comprises a solvent selected from the group consisting of propylene carbonate, ethylene carbonate, fluoroethylene carbonate, dimethyl carbonate, diethyl carbonate, ethyl methyl carbonate, vinylene carbonate, γ-butyrolactone, 1,2-dimethoxyethane, 1,3-dioxolane, tetrahydrofuran, sulfolane, acetonitrile, and the combination thereof.

29. The hybrid energy storage device of claim 21, wherein the non-aqueous, lithium-containing solution comprises a dissociable salt selected from the group consisting of LiPF₆, LiBF₄, LiClO₄, LiAsF₆, LiB(_{C}₂O₄)₂, LiBF₂C₂O₄, LiPF₄C₂O₄, LiCF₃SO₃, LiN(CF₃SO₂)₂, LiN(C₂F₅SO₂)₂, LiC(CF₃SO₂)₃, and the combination thereof.

30. The hybrid energy storage device of claim 21, further comprising a separation layer, positioned between the positive electrode and the negative electrode.

31. The hybrid energy storage device of claim 30, wherein the separation layer comprises porous polymer, polymer composites, polymer/inorganic composites, natural fibers, synthetic fibers, or natural fiber/synthetic fiber composites having polymer materials selected from the group consisting of polyethylene, polypropylene, poly(ethylene terephthalate), poly(ethylene oxide), polyacrylonitrile, poly(methyl methacrylate), poly(vinylidene fluoride), poly(vinylidene fluoride co-hexafluoropropylene), poly(tetrafluoroethylene), and the combination thereof.
